(19) United States
(12) Patent Application Publication
(10) Pub. No.: US 2024/0046002 A1
(43) Pub. Date: Feb. 8, 2024

(54) SIMULATION SOFTWARE PLATFORM FOR MEMRISTIVE NANOWIRE NETWORKS

(71) Applicant: Emergentia, Inc., Altadena, CA (US)

(72) Inventors: Zdenka Kuncic, Sydney (AU); Adam Stieg, Los Angeles, CA (US); Natesh Ganesh, Boulder, CO (US)

(21) Appl. No.: 18/334,243

(22) Filed: Jun. 13, 2023

Related U.S. Application Data
(60) Provisional application No. 63/394,531, filed on Aug. 2, 2022.

(51) Int. Cl. G06F 30/18; G06F 30/20

(52) U.S. Cl. CPC G06F 30/18; G06F 30/20; G06F 2119/06

(57) ABSTRACT

A method for simulating a nanowire network structure and dynamics is presented. The method includes selecting a number of nanowires representing the nanowire network structure, where each nanowire is simulated with a mean length randomly drawn from a gamma distribution and an orientation selected from a uniform distribution. The method further includes identifying intersection points between overlapping nanowires within the nanowire network structure and representing the nanowire network structure with a graph representation in which the nanowires are represented as nodes and the intersection points are represented as edges. Further, simulating a source electrode on a first location of the nanowire network structure for simulating an applied input voltage, applying to the source electrode a time-varying input voltage having a fixed duration, and solving Kirchoff s current law equations for the time-varying input voltage to obtain a time-dependent voltage function across the nanowire network structure.

### CROSS-REFERENCE TO RELATED APPLICATION

This application claims the benefit of U.S. Provisional Patent Application No. 63/394,531, titled “SIMULATION SOFTWARE PLATFORM FOR MEMRISTIVE NANOWIRE NETWORKS,” which was filed on Aug. 2, 2022 and is incorporated herein by reference in its entirety.

### FIELD OF THE DISCLOSURE

This disclosure relates to a software platform for solving the problem of simulating the nanoscale device physics and complex network circuitry of self-assembled nanowires with memristive cross-points and contact electrodes. The simulation software platform enables interfacing with real-world streaming data for adaptive machine learning applications.

### BACKGROUND

An artificial intelligence/machine learning (AI/ML) infrastructure brings an abundance of benefits to any industry when appropriate ML models are selected. Most commonly, businesses rely on traditional ML to handle data collection, analysis, and predictions. Traditional ML involves only two primary pipelines one for training (responsible for data collection) and another one for making predictions (responsible for data analysis). Before an ML model can analyze real data, it goes through a round of training during which its parameters for data collection and analysis are set. To train the model, developers typically use batch learning techniques where the model receives the entire data set at once to generate the best predictions.

Although AI products are being marketed as “always learning, always evolving,” it is typically not the case if the product relies on this traditional batch-based ML model. This is because traditional ML is static i.e., it depends on parameters that do not change, making it great for horizontal scalability but causing problems in dynamic industries where data is evolving. And because there are only two pipelines for data collection/analysis and traditional ML models rely on past data to generate new predictions, one can never have true, real-time insights that are critical in industries where trends are constantly evolving.

Instead of having a two-channel or two-pipeline approach like in traditional ML, an adaptive ML relies on a single channel. Adaptive ML collects and analyzes data in sequential order, not all at once. Therefore, adaptive ML models are able to monitor and learn from the changes in both input and output values. This allows the adaptive ML model to adapt its data collection, grouping, and analysis methods based on new information. Thus, and as long as there is a stream of information coming in, adaptive ML models will continue updating and changing to provide the best predictors for future data.

In the realm of adaptive ML from streaming sensor data at the internet of things (IoT) edge, the vast majority of technologies still use cloud-based resources to train models and then deploy them to the edge (a distributed computing paradigm that brings computation and data storage closer to the sources of data) for inference using graphic processing units (GPU) or other custom hardware for acceleration. However, significant research and development efforts are underway to shift, the paradigm to on-device training. This requires new low-power hardware and also new lean algorithms suitable for adaptive ML.

The foregoing discussion, including the description of motivations for some embodiments, is intended to assist the reader in understanding the present disclosure, is not admitted to be prior art, and does not in any way limit the scope of any of the claims.

### SUMMARY

The simulation software platform described herein enables interfacing with real-world streaming data for adaptive ML applications. In particular, the simulation software platform converts continuous-time data streams (e.g., like the ones produced by different kinds of sensors such as temperature, pressure, motion, electromagnetic and the like) into normalized electrical signals (e.g., voltage pulses), and uses the normalized electrical signals as inputs to perform an input-output mapping (e.g., a non-linear transformation) and produce outputs with dynamical features. These outputs enable efficient and adaptive ML for a variety of tasks, including but not limited to: classification, regression, anomaly detection, and time-evolving data prediction. According to some embodiments, multiple inputs may be used to generate multiple outputs, thereby enabling learning from complex, multi-dimensional streaming data, which is otherwise challenging using conventional ML methods.

According to some embodiments, the simulation software platform simulates a network of self-assembled nanowires (SAN) having memristive cross-points and contact electrodes. The network of SAN is capable of receiving temporal input signals to produce higher dimensional space, linearly separable outputs, which can be subsequently used as input to an adaptive ML model. This means that the adaptive ML model can use linear combinations for the analysis of its input data, which significantly simplifies the task at hand. In other words, the memristive portion of the SAN network nonlinearly transforms temporal input signals into a higher-dimensional space such that output dynamical features are linearly separable, thus enabling efficient linear algorithms to be applied to the SAN output for ML tasks.

The foregoing is a summary and thus contains, by necessity, simplifications, generalizations and omissions of detail; consequently, the summary is illustrative only and is not limiting in any way. Other aspects, inventive features, and advantages of the systems and/or processes described herein will become apparent in the non-limiting detailed description set forth herein.

### BRIEF′ DESCRIPTION OF THE DRAWINGS

Certain advantages of some embodiments may be understood by referring to the following description taken in conjunction with the accompanying drawings. In the drawings, like reference characters generally refer to the same parts throughout the different views. Also, the drawings are not necessarily to scale, emphasis instead generally being placed upon illustrating principles of some embodiments of the invention.

Figure (FIG. 1 is an exemplary SAN network made from individual nanowires distributed across a 2D surface, according to some embodiments.

FIG. 2 is a flow chart of a method describing the operations performed by a simulation software platform, according to some embodiments.

FIG. 3 is an exemplary depiction of a SAN network structure and its corresponding graphical representation used by a simulation software platform, according to some embodiments.

FIG. 4 is an exemplary graphical representation of a complex SAN network structure, according to some embodiments.

FIG. 5 is a time snapshot representation of a graphical SAN network dynamics, according to some embodiments.

### DETAILED DESCRIPTION OF THE DISCLOSURE

### I. Description of the Self-Assembled Nanowire (SAN) Network

According to some embodiments, the SAN network is a physical construct formed spontaneously on a surface under certain growth conditions. The number of nanowires, their heterogeneity, irregularity, and distribution across a two-dimensional (2D) surface may be partially controlled via the growth parameters. In other words, the SAN network is not entirely random. In some embodiments, the SAN network is formed with a bottom-up, self-assembly process. At locations where individual nanowires touch, memristive cross-point junctions are formed. As a result, the SAN network forms a highly complex electrical circuitry that cannot be simulated with standard software such as Cadence and SPICE developed for top-down, design-driven circuits.

FIG. 1, shows an exemplary SAN network made from individual nanowires distributed across a 2D surface according to the description provided above. In some embodiments, the SAN network shown in FIG. 1 is formed as part of an integrated circuit (IC) within a chip, and is communicatively coupled to other components of the IC within the chip and/or outside the chip. By way of example and not limitation, the SAN network may receive and transmit signals from and to components that are internal and/or external to the chip. The nanowires, which resemble sticks of different lengths, are allowed to overlap with each other t form memristive cross-point junctions.

As discussed above, the SAN network forms a highly complex electrical circuitry. In some embodiments, the SAN network is configured to receive one or more input signals in the form of a time-varying (e.g., temporal) voltage signal and produce multiple output signals read from desired network locations. According to some embodiments, the resistance of the memristive junctions changes asynchronously and non-linearly with time. Consequently, the current flowing within each nanowire is subject to change, and so are the output signals of the SAN network. Because the SAN network is inherently non-linear, it is capable of non-linearly transforming the input signal(s) to outputs that are linearly separable. This is analogous to applying one or more non-linear activation functions in a traditional neural network. However, in the case of the SAN network, the non-linear activation function is dynamic, due to the memristive nature of the junctions formed between the overlapping portions of the nanowires, and asynchronous, due to the heterogeneous network structure (i.e. not fully connected bipartite layers).

In some embodiments, the dimensions of the output signal increases according to the number of locations selected for the output readout. For example, the number of the outputs increases as the number of readout locations increases. In some embodiments, and as shown in FIG. 1 the number of outputs is selected to be greater than the number of inputs. Thus, the output corresponds to a higher-dimensional space. It is noted however that the term higher-dimensional space also refers to the dynamic feature diversity of the output signals compared to the received input signal(s). And because the multiple outputs are very different from the inputs, it is possible to linearly combine them to produce a “richer” signal. For example, in nonlinear waveform regression, using a single-frequency sinusoid as input, the SAN network can produce outputs that are linearly regressed to a square wave, which has infinitely many higher-order harmonics compared to the input signal.

According to some embodiments, the output signal from the SAN network is subsequently fed into a linear output layer of a ML model, as shown in FIG. 1. And because the outputs of the SAN network are linearly separable, computationally efficient linear algorithms can be applied for ML tasks. This in turn simplifies the computational burden on the ML hardware. Therefore, systems with limited computational power, memory, and bandwidth resources can now benefit by running lean algorithms with lower computational cost compared to traditional artificial neural networks (ANN).

In some embodiments, the SAN network is simulated by the simulation software platform described herein. The simulation software platform simulates the behavior of the SAN network allowing a user to understand how the voltage is distributed across the network structure, and therefore, the behavior of the entire network as it receives the temporal input. According to some embodiments, the simulation software platform: (i) models resistive memory switching device physics more realistically than other memristor models, (ii) solves more complex electrical circuitry than conventional software (e.g. Cadence and SPICE), (iii) simulates adaptive NIL tasks implemented more efficiently with nanowire network hardware devices than with ANN or with reservoir computing, and (iv) analyzes the dynamics of nanowire network devices more comprehensively than other prior approaches.

### II. Description of the Simulation Software Platform

According to some embodiments, analysis of the network dynamics is performed using modified open-source network neuroscience software (such as NetworkX, Brain Connectivity Toolbox) adapted to memristive nanowire networks i.e., by modeling memristive junctions and applying electrical circuit laws. This is different from prior approaches that analyze nanowire networks using grid-based methods rather than network-based methods.

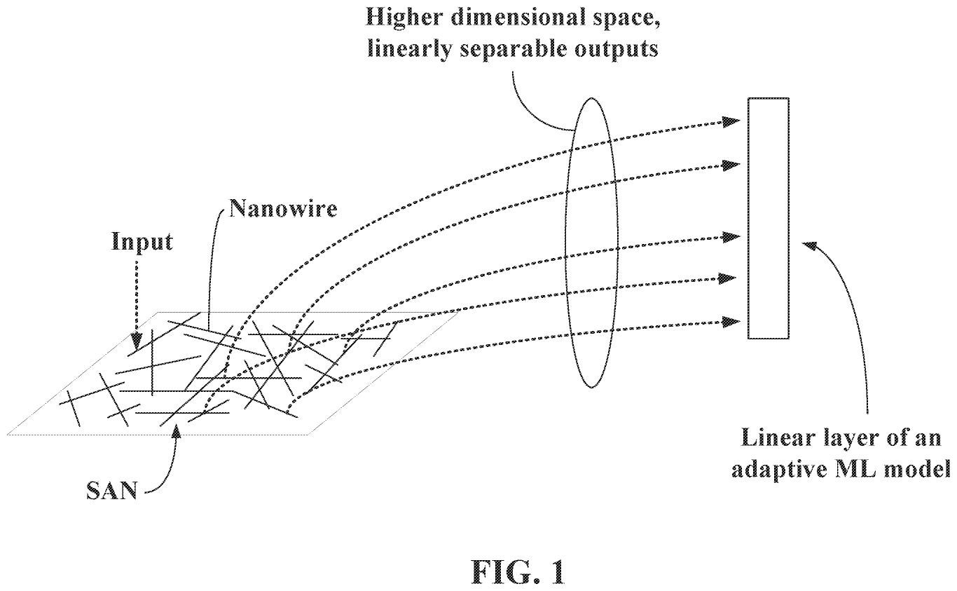

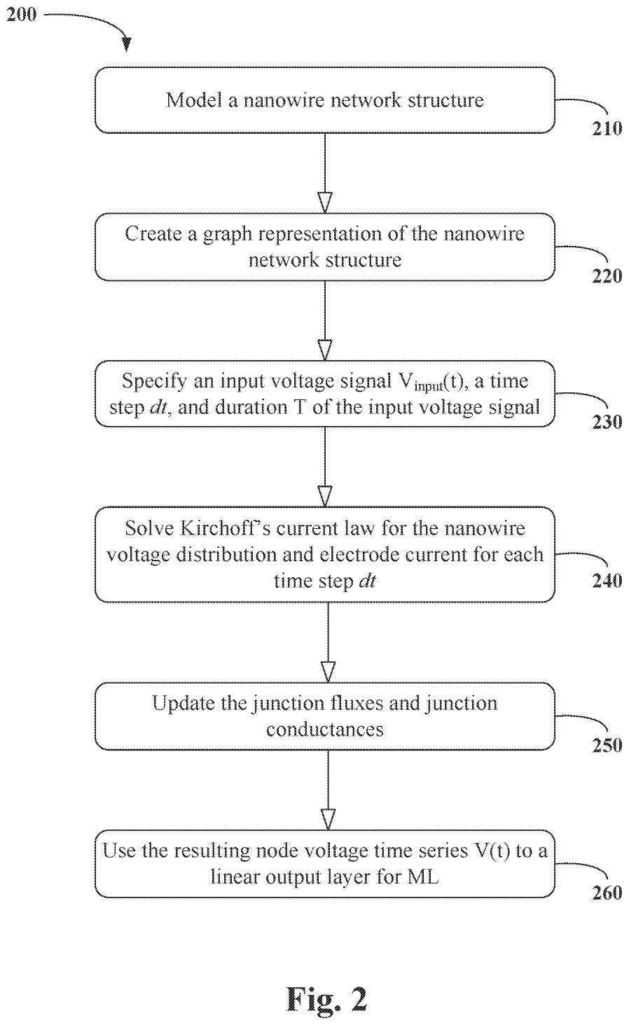

According to some embodiments, FIG. 2 shows a method 200 describing the operations performed by the simulation software platform in the form of a flow chart. Other operations may be performed between the various operations of method 200 and may be omitted merely for simplicity. This disclosure is not limited to the operational description of method 200. It is to be appreciated that additional operations may be performed. Moreover, not all operations may be needed to perform the disclosure provided herein. Additionally, some of the operations may be performed simultaneously, or in a different order than shown in FIG. 2. In some embodiments, one or more other operations may be performed in addition to or in place of the presently described operations.

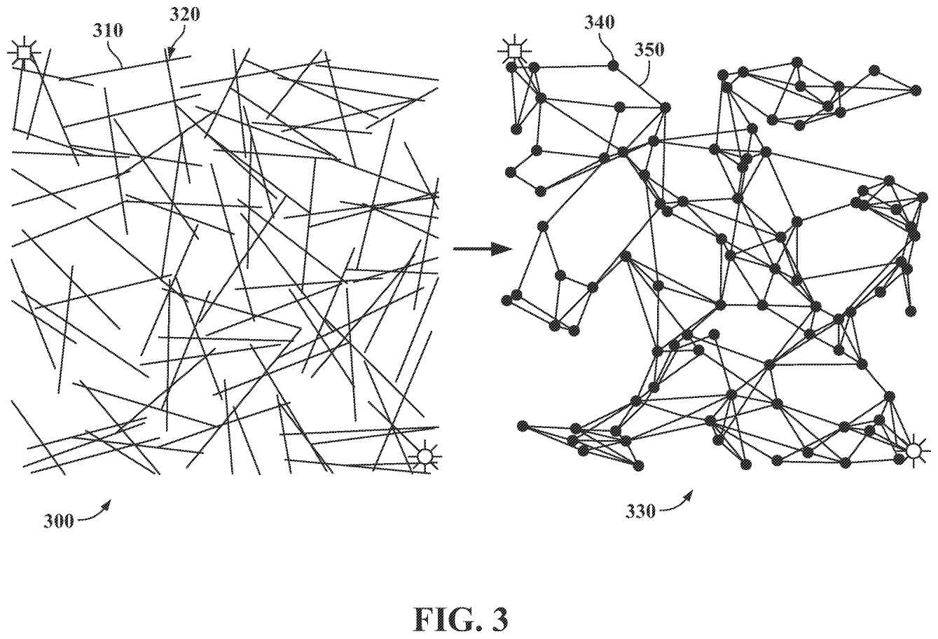

As shown in FIG. 2, method 200 begins with operation 210 in which the simulation software platform models a nanowire network structure. In some embodiments, the nanowire network structure is modeled by selecting N number of nanowires having lengths randomly, drawn from a gamma distribution. In some embodiments, the number N of nanowires modeled is greater than ₁₀₀ (e.g., N>100). The nanowires have a mean length <L> ranging between 5 μm and 100 μm, a standard deviation σ ranging between 1 μm and 20 μm, and are scattered on a 2D plane over an area A ranging between 10 and 200 μm². The position and orientation θ of each nanowire are selected from uniform distributions. For example, the orientation θ of each nanowire is selected from a uniform distribution with values between 0 and it (e.g., 0≤θ≤π). By way of example and not limitation, a nanowire network structure 300 having nanowires 310 and modeled in operation 210 is shown in FIG. 3. Intersection points 320 are identified based on the resulting nanowire distribution shown in FIG. 3. Intersection points 320 are formed at locations where two or more nanowires 310 overlap and correspond to the memristive junctions discussed above. According to some embodiments, and for a network with a fixed number N of nanowires (e.g., N=100), the number of intersection points 320, M, is greater than 250 (e.g., M>250). According to some embodiments, if M is substantially lower that 250 (e.g., M≤200), the nanowire network structure can be prohibitively resistive. Conversely, if M is too high (e.g., M≥1000), the nanowire network structure may act as a bulk conductor. Accordingly, an optimization process may be necessary to determine the size of nanowire network structure 300 depending on the application.

In referring to FIG. 2 and back to FIG. 3, method 200 continues with operation 220 and the process of creating a graphical representation 330 of nanowire network structure 300. In graphical representation 330, nanowires 310 and junctions 320 from nanowire network structure 300 are represented as nodes 340 and edges 350, respectively. Accordingly, the number of nodes 340 in graphical representation 330 is equal to the number of nanowires 310 in nanowire network structure 300, and respectively, the number of edges 350 is equal to the number of junctions 320. According to some embodiments, the length of edges 350 in the graphical representation 330 does not have a 1:1 mapping with the physical system. However, the number of edges 350 between any pair of nodes 340 physically represents the shortest electrical path (i.e. path of least resistance, if the memristors have all switched on to a low resistance state). Graphical representation 330 can be thought of as a graphical representation of a connectivity adjacency matrix for nanowire network structure 300. In some embodiments, graphical representation 330 allows for Kirchoff s circuit law (KCL) to be solved as a system of linear equations using modified nodal analysis.

In referring to FIG. 2, method 200 continues with operation 230 in which an input voltage signal Vᵢₙₚᵤₜ (t), a time step dt, and duration T of the input voltage signal are specified. Ratio T/dt determines the number of iterations. Vᵢₙₚᵤₜ(t) represents a temporal voltage signal (i.e., a time dependent voltage signal) with a maximum amplitude of 10 Volts and a minimum amplitude of 10⁻³ Volts. According to some embodiments, the input voltage signal Vᵢₙₚᵤₜ(t) is a direct current (DC) voltage, an alternating current (AC) voltage, or a custom voltage signal. The input voltage is applied by a predetermined number of point contact electrodes that place memristive loads on junctions 320 of nanowire network structure 300. In some embodiments, the number of point contact electrodes is equal to or greater than two (e.g., ≥2) so that at least one electrode becomes the designated source of the Vᵢₙₚᵤₜ(t) signal and at least one electrode becomes the designated grounded drain.

In the example of FIG. 3, the source electrode is identified with a square and the drain electrode is identified with a circle. As discussed above, the number of point electrodes used in FIG. 3 is not limiting, and additional number of point electrodes may be used. In some embodiments, the placement of the source electrode(s) is either random or manual while the placement of the drain electrode(s) is manual at any desired locations.

As memristance across the memristive junctions i.e., edges 350 or junctions 320 changes asynchronously with time, KCL is solved for the nanowire voltage distribution and current for each time step di using the modified nodal analysis method, according to operation 240 of method 200. The system of linear equations in block matrix form is provided in Equation (1) below:

$$( \begin{matrix}\tilde{G} & {C}^{T} \\ C & 0\end{matrix} ) ( \begin{matrix}V \\ I\end{matrix} ) = ( \begin{matrix}0 \\ S\end{matrix} ) . \qquad ( 1 )$$

It is noted that the number of total linear equations to be solved is equal to the total number N of nanowires simulated. The first row \tilde{G}V+C^{T}1=0 corresponds to Kirchoff s current law according to which the sum of all currents entering and leaving a node 340 in graphical representation 330 of FIG. 3 must be equal to zero. Further, \tilde{G}=G−dia(sum(G)) with Gᵢⱼ being the conductance of a memristive junction between nanowires i and j. According to some embodiments, C represents electrical contact points between the nano wires and respective external electrodes used to deliver and receive electrical signals to and from the nanowire network. Accordingly, Cᵢⱼ is equal to one (e.g., Cᵢⱼ=1) if j is the nanowire index of the i-th electrode, and equal to zero (e.g., Cᵢⱼ=0) otherwise. Further, I is the electrode current.

In the second row, CV=S, S is the voltage on the contact electrode and Vis the time-dependent voltage on all nodes 340. According to some embodiments, equation CV=S defines the time-dependent voltages V(t) applied to the electrodes making point contact with nanowires 310, wherein at least one electrode is being grounded while others are allocated as input electrodes.

Once V(t) is solved, the voltage drop Vᵢⱼ=Vᵢ−Vⱼ across all memristive junctions 320 (or memristive edges 350) is calculated and the conductance of a memristive junction, Gᵢⱼ, is updated using Equation (2) below:

Gᵢⱼ(λ)=Gₘₑₘ(λ)+G_{off} (2).

As shown in Equation 2, the conductance of a memristive edge 350, Gᵢⱼ, is a function of flux A, which is also a time-dependent quantity i.e., λ=λᵢⱼ(t). According to some embodiments, the off-state conductance G_{off} is less than the conductance quantum G₀—i.e., G_{off}<<G₀=(12.9 kΩ)⁻¹. Gₘₑₘ(λ) is the component of memristive conductance provided by Equation (3) below:

Gₘₑₘ(λ)[R_{diff}(A)+Rₜᵤₙ(Δ)+Rₒₙ]⁻¹ (3).

According to Equation 3, Gₘₑₘ(λ) varies with flux λ=λᵢⱼ(t) as a result of the non-linear resistance behavior due to ion diffusion R_{diff} and electron tunneling Rₜᵤₙ; the latter being dependent on the junction thickness sₘₐₓ and tunneling energy barrier r based on the Simmons formula. In some embodiments, sₘₐₓ ranges between 2 nm and 10 nm, and ranges between 0.4 eV and 1.2 eV. Finally, Rₒₙ=G₀⁻¹ is the resistance of a memristive junction in an “on” state as a conductive nano-filament (e.g., a silver (Ag) nano-filament) is formed across the junction.

In some embodiments, the internal dynamics of the nanoscale junction is modelled with a “soft switching” tank function provided by Equation (4) below:

$$\frac{d λ}{dt} = f ( x ) [ {V}_{ij} - {V}_{set} tanh ( \frac{{V}_{ij}}{{V}_{set}} ) ] , \qquad ( 4 )$$

where f(x) is an arbitrary linear function of x=λ/λₘₐₓ (e.g., f(x)=1−x), with Vₛₑₜ being a set threshold voltage above which nano-filaments are formed by an electro-chemical metallization process (i.e., a process by which memristive switching occurs when a sudden change in the resistance state occurs due to the formation of a conducting bridge (e.g., a filament of metal atoms) across the nanoscale memristive junction). According to some embodiments, Vₛₑₜ is not restricted to a fixed parameter and may vary from junction to junction. In this context, the term “soft switching” refers to a sigmoidal-like change, as opposed to a “sudden” step function-like change. In some embodiments, and according to operation 250, Equation (4) is used to update the fluxes λ(t) across all the memristive junctions at each time step dt via the Euler method using Equation (5) below:

$$λ ( t ) = λ ( t - 1 ) + \frac{d λ}{dt} * dt . \qquad ( 5 )$$

Subsequently, and based on the updated fluxes, the conductance of a memristive junction, is also updated using Equation (2) above.

According to some embodiments, the process of solving KCL and updating the fluxes and the conductances of the memristive junctions is repeated for all time steps di. At that point, and according to operation 250, the node voltage time series VW is provided as an input parameter to a linear output layer of an adaptive MIL model.

According to some embodiments, Table 1 below summarizes the ranges for some key parameters of method 200 used by the disclosed simulation software platform.

TABLE 1

| Parameter | Description | Operating range |
|---|---|---|
| N | Number of nanowire nodes | >100 |
| M | Number of memristive edges | >250 |
| <L> | Mean length of each nanowire | 5 to 100 μm |
| σ | Standard deviation of L | 1 to 20 μm |
| θ | Angular orientation of each nanowire | [0, π] |
| A | 2D grid area for randomly dispersing | 10 to 200 μm² |
| | nanowires (uniformly sampled) | |
| dt | Time step | 10⁻³ to 10⁻¹ s |
| Vᵢₙₚᵤₜ(t) | Input voltage signal | 10⁻³ to 10 V |
| Vₛₑₜ | Set threshold voltage | 10⁻² to 0.5 V |
| λ(t) | Flux (nano-filament parameter) | [−1, +1]*λₘₐₓ |
| λₘₐₓ | Maximum flux | 0.1 to 0.2 Vs |
| λ_{crit} | Critical flux value | 10⁻⁴ to 0.1 Vs |
| G₀ | On-state conductance | (12.9 kΩ)⁻¹ |
| G_{off} | Off-state conductance | [0.1, 10⁻⁴]*G₀ |
| sₘₐₓ | Junction thickness | 2 to 10 nm |
| ϕ | Potential energy barrier for tunneling | 0.4 to 1.2 eV |

### III. Memristive Edges

According to some embodiments, each memristive junction 320 or edge 350 in FIG. 3 is modeled by the simulation software platform described herein as a voltage-controlled, threshold-driven bipolar memristor governed by the following coupled equations (6) and (7):

I(t)=Ψ(λ,V,t)V(t) (6)

\dot{λ}=Φ(λ,V,t) (7)

where I is the current, V the voltage and \dot{λ} is the flux representing internal memory. According to some embodiments, Ψ and Φ are generic nonlinear functions used to describe a general memristor device as opposed to an Ohmic device in which Ψ would be equal to a constant conductance value. This means that flux A depends on the past history of states. In physical terms, \dot{λ} represents the evolution of a conductive nano-filament that forms or decays as a result of electro-chemical metallization through a nanoscale electrolytic material, such as silver-selenide (Ag₂Se).

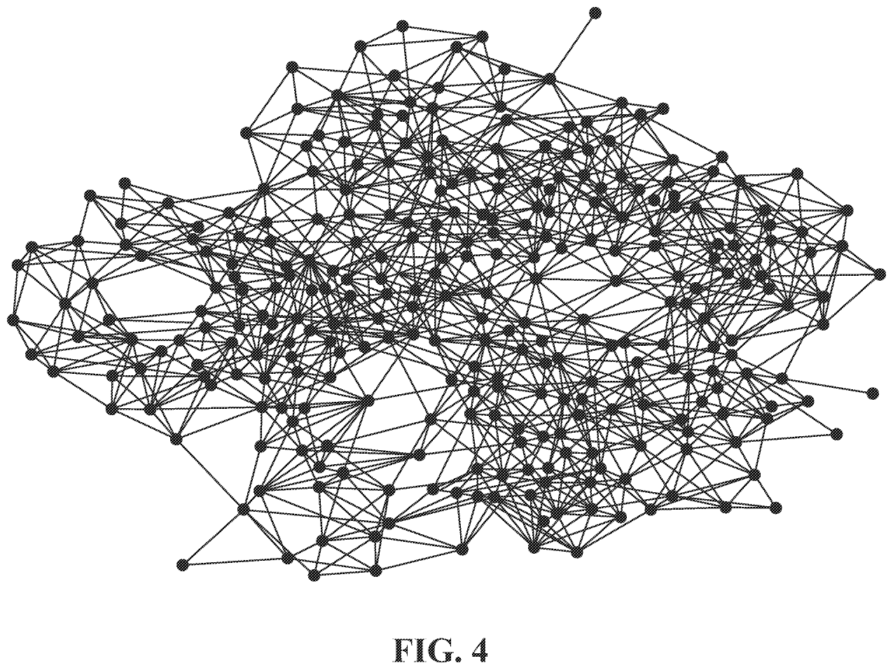

Memristor elements are connected in a non-trivial nanowire network circuitry of variable size. FIG. 4 shows another exemplary graphical representation of a nanowire network structure that is similar to graphical representation 330 shown in FIG. 3 but substantially more complex. The simulation software platform solves KCL at each time step dt using graph theory and modified nodal analysis. The interplay between network connectivity and memristive edges results in emergent dynamics (i.e., beyond what is Observed for a single memristor element), even when the input signal is constant in time i.e., when DC bias is applied for a long duration. If the nanowire network structure was regular (e.g., a conventional circuit with memristive elements connected serially or in parallel), the resulting dynamics would not be sufficiently rich/diverse to perform well in a ML model. Consequently, circuitry complexity is hey for leveraging the memristive elements so that the emergent dynamics is maximally rich and diverse, and thus suitable for adaptive ML.

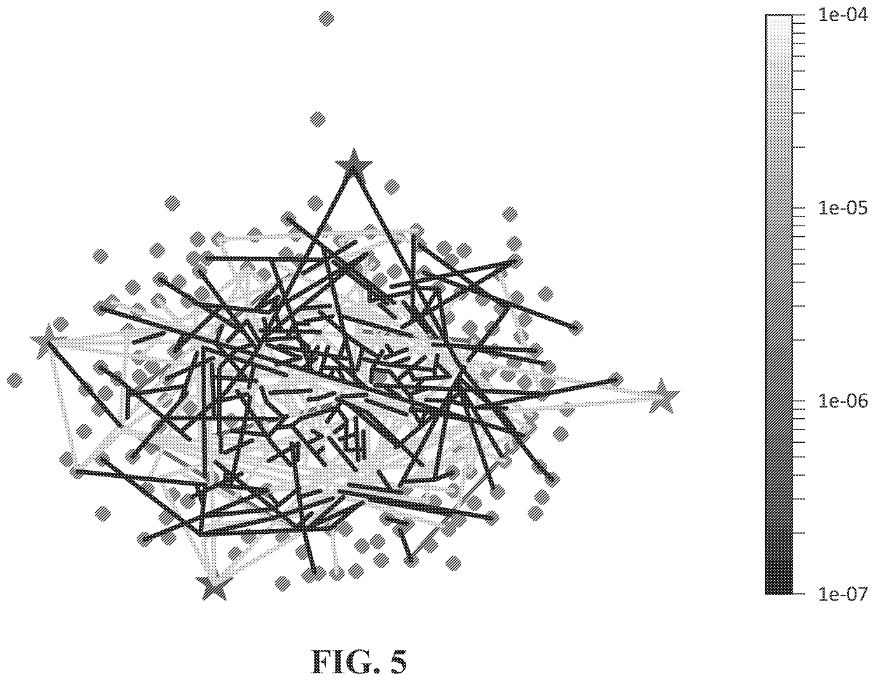

In some embodiments, the simulation software platform calculates the internal dynamics of memristive junctions and produces a movie clip that shows how the network operates for a given implementation. For example, the movie clip can show how conductance evolves as a function of time across the memristive junctions. An example is provided in FIG. 5 where a snapshot from a movie clip is shown. In the snapshot of FIG. 5, the color mapping represents conductance distribution across the memristive junctions corresponding to a particular instance.

### IV. User Case Examples

By way of example and not limitation, the simulation software platform is intended to operate in commercial product development environments. End-users can be engineers in commercial entities co-designing and developing full-stack software for nanowire device technology. Ensuing products will enable adaptive, online ML applications (e.g., prediction, classification) on sensor edge devices to generate high throughput streaming data on limited computational, memory, and bandwidth resources. According to some embodiments, the simulation software platform described herein enables research and development for smart autonomous systems at the sensor edge in sectors such as advanced manufacturing and robotics (e.g., in industrial automation, process & environment monitoring), environmental sustainability monitoring (e.g., renewables for smart cities, communities and factories), and remote industries (e.g., marine, mining, aviation/aerospace, space) and the like.

By way of example and not limitation, some user case examples are provided below.

### Example 1: Image Classification

By way of example and not limitation, the pixels from an image may be converted into a one-dimensional (1D) data stream by scanning, for example, the imaged row-by-row or column-by-column while converting each pixel's intensity to a normalized voltage pulse for example, with 1 Volt as the maximum amplitude within a temporal segment Δt. Subsequently, the ID data stream is delivered to the nanowire network structure and the resulting node voltages V(t) are used to train linear weights W in an external layer of an adaptive ML model. This external layer may be represented in a matrix form as W×X=Y_{n×m}, where Y is a matrix with one dimension equal to the number of classes n and the other dimension equal to the number to training samples in (e.g., n×m). In this context, W is a matrix with one dimension equal to the number to training samples in and another dimension equal to the number of pixels (e.g., m×no, of pixels), and X is a matrix with one dimension equal to the number of pixels and another dimension equal to the number of classes n (no. of pixels×n). In a classification task, classes represent categories of objects (e.g., images) that need to be recognized. For example, images of numbers from 0-9 has 10 classes with each digit being a class. According to some embodiments, W can also be trained online, using an update rule, which can be advantageous for streaming data.

### Example 2: Regression

By way of example and not limitation, linear weights W can be trained to fit a specified target signal, Y(t), from the output node voltages V(t). Piecewise linear regression e.g., where the signal is divided into temporal segments Δt—can improve the task performance.

### Example 3: Time-Series Prediction

By way of example and not limitation, linear weights W can be trained to predict the next value of an unpredictable signal using auto-regression, where W is trained from a fixed number of past history states of the network—i.e., V(t−1), V(t−2), . . . , V(t−n), where each V is voltage from multiple nodes.

What is claimed is:

1. A method of simulating a nanowire network structure, the method comprising:
selecting a number of nanowires representing the nanowire network structure, wherein each nanowire is simulated with a mean length randomly drawn from a gamma distribution and an orientation selected from a uniform distribution;
distributing the nanowires on a plane;
identifying intersection points between overlapping nanowires within the nanowire network structure, wherein the intersection points form memristive junctions between touching nanowires;
representing the nanowire network structure with a graph representation in which the nanowires are represented as nodes and the intersection points are represented as edges;
simulating a source electrode on a first location of the nanowire network structure for simulating an applied input voltage and a grounded drain electrode on a second location of the nanowire network structure;
applying to the source electrode a time-varying input voltage having a fixed duration;
wherein the time-varying input voltage results in a current flow across the memristive junctions of the nanowire network structure so that the memristive junctions of the nanowire network structure develop a junction flux and a respective junction conductance;
solving Kirchoff s current law equations for the time-varying input voltage and the resulting current flow across the memristive junctions to obtain a time-dependent voltage function across the nanowire network structure; and
updating the junction flux and the junction conduction based on the time-dependent voltage function.

2. The method of claim 1, wherein the number of nanowires in the nanowire structure is greater than 100.

3. The method of claim 1, wherein the mean length of each nanowire is between 5 μm and 100 μm.

4. The method of claim 1, wherein the orientation of each nanowire has a value between 0 and π.

5. The method of claim 1, wherein the plane has an area between 10 μm² and 200 μm².

6. The method of claim 1, wherein the junction flux is a time-dependent quantity whose internal dynamics are modelled with a tank function provided by equation:
$$\frac{d λ}{dt} = f ( x ) [ {V}_{ij} - {V}_{set} tanh ( \frac{{V}_{ij}}{{V}_{set}} ) ]$$

7. The method of claim 1, wherein the junction conduction varies with the junction flux as a result of a non-linear behavior due to ion diffusion and electron tunneling within the memristive junctions.

8. The method of claim 1, wherein solving Kirchoff s current law equations for the time-varying input voltage comprises solving Kirchoff s current law equations for a plurality of time steps and updating the junction flux and the junction conduction for each time step to obtain a voltage time series.

9. The method of claim 8, further comprising feeding the voltage time series to a linear output layer of an adaptive ML model.

10. The method of claim 1, wherein solving, Kirchoff's current law equations for the time-varying input voltage involves selecting one or more readout locations across the nanowire network structure and measuring a voltage drop and a current flow from each one of the one or more readout locations.

11. A computer program product for simulating a nanowire network structure, the computer program product comprising a non-transitory computer-readable medium having computer readable program code stored thereon, the computer readable program code configured to:
select a number of nanowires representing the nanowire network structure, wherein each nanowire is simulated with a mean length randomly drawn from a gamma distribution and an orientation selected from a uniform distribution;
distribute the nanowires on a plane;
identify intersection points between overlapping nanowires within the nanowire network structure, wherein the intersection points form memristive junctions between touching nanowires,
represent the nanowire network structure with a graph representation in which the nanowires are represented as nodes and the intersection points are represented as edges;
simulate a source electrode on a first location of the nanowire network structure for simulating an applied input voltage and a grounded drain electrode on a second location of the nanowire network structure;
apply to the source electrode a time-varying input voltage having a fixed duration, wherein the time-varying input voltage results in a current flow across the memristive junctions of the nanowire network structure so that the memristive junctions of the nanowire network structure develop a junction flux and a respective junction conductance;
solve Kirchoff s current law equations for the time-varying input voltage and the resulting current flow across the memristive junctions to obtain a time-dependent voltage function across the nanowire network structure; and
update the junction flux and the junction conduction based on the time-dependent voltage function.

12. The computer program product of claim 11, wherein the number of nanowires in the nanowire structure is greater than 100.

13. The computer program product of claim 11, wherein the mean length of each nanowire is between 5 μm and 100 μm.

14. The computer program product of claim 11, wherein the orientation has a value between 0 and π.

15. The computer program product of claim 11, wherein the plane has an area between 10 μm² and 200 μm².

16. The computer program product claim 11, wherein the junction flux is a time-dependent quantity whose internal dynamics are modelled with a tank function provided by equation:
$$\frac{d λ}{dt} = f ( x ) [ {V}_{ij} - {V}_{set} ( \frac{{V}_{ij}}{{V}_{set}} ) ]$$

17. The computer program product 11, wherein the junction conduction varies with the junction flux as a result of a non-linear behavior due to ion diffusion and electron tunneling within the memristive junctions.

18. The computer program product of claim 11, wherein the computer readable program code is configured to solve Kirchoff s current law equations for a plurality of time steps and update the junction flux and the junction conduction for each time step to obtain a voltage time series.

19. The computer program product of claim 18, wherein the computer readable program code is further configured to feed the voltage time series to a linear output layer of an adaptive ML model.

20. The computer program product of claim 11, wherein the computer readable program code when solving Kirchoff s current law equations for the time-varying input voltage is configured to select one or more readout locations across the nanowire network structure and measure a voltage drop and a current flow from each one of the one or more readout locations.
